(19) United States
(12) Patent Application Publication
(10) Pub. No.: US 2013/0169723 A1
(43) Pub. Date: Jul. 4, 2013

(54) INKJET PRINT HEAD

(71) Applicant: SAMSUNG ELECTRO-MECHANICS CO., LTD., Suwon (KR)

(72) Inventors: Pil Joong KANG, Suwon (KR); Seung Joo Shin, Suwon (KR); Tae Kyung Lee, Suwon (KR); Hwa Sun Lee, Suwon (KR)

(73) Assignee: SAMSUNG ELECTRO-MECHANICS CO., LTD., Suwon (KR)

(21) Appl. No.: 13/710,742

(22) Filed: Dec. 11, 2012

(30) Foreign Application Priority Data
Dec. 29, 2011 (KR) 10-2011-0145371

(51) Int. Cl. B41J 2/175

(52) U.S. Cl. CPC B41J 2/17513
USPC 347/87

(57) ABSTRACT

There is provided an inkjet print head including: an ink discharge unit including nozzles, pressure chambers, restrictors, manifolds, and actuators; an ink supply unit including an ink tank supplying ink to the manifolds and circuit boards delivering control signals to the actuators; and a connection unit electrically connecting the circuit boards and the actuators, wherein the ink supply unit is formed integrally with the ink discharge unit.

### CROSS-REFERENCE TO RELATED APPLICATIONS

This application claims the priority of Korean Patent Application No. 10-2011-0145371 filed on Dec. 29, 2011, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head capable of being miniaturized and performing high resolution printing.

2. Description of the Related Art

An inkjet print head is a device converting an electrical signal into physical force to discharge stored ink in droplets. This inkjet print head may include a substrate including a pressure chamber and a nozzle, an actuator pressurizing the pressure chamber, an ink tank supplying ink to the pressure chamber, and a circuit board transferring an electrical signal to the actuator.

Here, the ink tank and the circuit board occupy a significantly large area of the inkjet print head.

However, in the inkjet print head according to the related art, since the ink tank and the circuit board are disposed to be aligned in a length direction of the pressure chamber or the actuator (that is, a width direction of the inkjet print head), it may be difficult to miniaturize the inkjet print head in the width direction.

### SUMMARY OF THE INVENTION

An aspect of the present invention provides an inkjet print head capable of being miniaturized.

Another aspect of the present invention provides an inkjet print head capable of improving printing resolution through miniaturization.

According to an aspect of the present invention, there is provided an inkjet print head including: an ink discharge unit including nozzles, pressure chambers, restrictors, manifolds, and actuators; an ink supply unit including an ink tank supplying ink to the manifolds and circuit boards delivering control signals to the actuators; and a connection unit electrically connecting the circuit boards and the actuators, wherein the ink supply unit is formed integrally with the ink discharge unit.

The ink supply unit may include a penetration hole into which the connection unit is inserted.

The connection unit may be a wire inserted into the penetration hole.

The penetration hole may be filled with an epoxy resin so as to allow the wire to be stably fixed therein.

An inner wall of the penetration hole may be coated with an insulating material.

The penetration hole may include a first oxide film formed on a lower inner wall thereof and a second oxide film formed on an upper inner wall thereof, and the second oxide film may have a thickness greater than that of the first oxide film.

The ink supply unit and the ink discharge unit may further include an oxide layer formed therebetween.

The ink supply unit may include a channel connecting the manifolds and the ink tank.

The channel may be provided with a pillar for reducing a pressure wave generated during an ink discharging operation by the actuators.

The pillar may have a penetration hole formed therein and having the connection unit inserted thereinto.

The ink tank may be disposed at a bisection point of the ink supply unit in a first length direction.

The nozzles, the pressure chambers, the restrictors, the manifolds, and the actuators may be formed to be symmetrical with respect to the ink tank.

The circuit boards may be disposed to be symmetrical with respect to the ink tank.

The ink discharge unit may include: a first substrate having the nozzles formed therein; a second substrate having the pressure chambers and the manifolds formed therein; and a third substrate having the restrictors and ink inlets formed therein, the restrictors connecting the pressure chambers and the manifolds, and the ink inlets connecting the manifolds and the ink tank.

The ink discharge unit may include: a first substrate having the nozzles formed therein; and a second substrate having the pressure chambers, the restrictors, the manifolds, and ink inlets formed therein, the ink inlets connecting the manifolds and the ink tank.

The ink supply unit may include: a fourth substrate having a first channel and a first penetration hole formed therein, the first channel being connected to the manifolds, and the first penetration hole having the connection unit inserted thereinto; a fifth substrate having a second channel and a second penetration hole formed therein, the second channel connecting the ink tank and the first channel, and the second penetration hole being connected to the first penetration hole; the circuit boards formed on the fifth substrate and connected to the actuators; and the ink tank formed on the fifth substrate and supplying the ink to the pressure chambers.

According to another aspect of the present invention, there is provided an inkjet print head including: an ink discharge unit including nozzles, pressure chambers, and actuators; an ink supply unit including circuit boards delivering control signals to the actuators; and a connection unit electrically connecting the circuit boards and the actuators, wherein the ink supply unit is formed integrally with the ink discharge unit.

The ink supply unit may include a penetration hole into which the connection unit is inserted.

The connection unit may be a wire inserted into the penetration hole.

The penetration hole may be filled with an epoxy resin so as to allow the wire to be stably fixed therein.

An inner wall of the penetration hole may be coated with an insulating material.

The penetration hole may include a first oxide film formed on a lower inner wall thereof and a second oxide film formed on an upper inner wall thereof, and the second oxide film may have a thickness greater than that of the first oxide film.

The ink supply unit and the ink discharge unit may further include an oxide layer formed therebetween.

The ink supply unit may include a channel connected to the pressure chambers.

The channel may be provided with a pillar for reducing a pressure wave generated during an ink discharging operation by the actuators.

The pillar may have a penetration hole formed therein and having the connection unit inserted thereinto.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view of an inkjet print head according to a first embodiment of the present invention;

FIG. 2 is a cross-sectional view of the inkjet print head of FIG. 1 taken along line A-A;

FIG. 3 is a cross-sectional view of the inkjet print head of FIG. 1 taken along line B-B;

FIG. 4 is a cross-sectional view of an inkjet print head according to a second embodiment of the present invention;

FIG. 5 is a cross-sectional view of an inkjet print head according to a third embodiment of the present invention; and

FIG. 6 is a cross-sectional view of an inkjet print head according to a fourth embodiment of the present invention.

### DETAILED DESCRIPTION OF THE PREFERRED EMBODIMENT

Hereinafter, embodiments of the present invention will be described in detail with reference to the accompanying drawings.

In describing the present invention below, terms indicating components of the present invention are named in consideration of functions of each component. Therefore, the terms should not be understood as being limited technical components of the present invention.

An inkjet print head may include a pressure chamber extending in a first direction (generally a width direction of the inkjet print head) and an actuator formed over the pressure chamber to extend in a length direction (that is, the first direction) of the pressure chamber.

In addition, the inkjet print head may include an ink tank (an ink storing part) supplying ink to the pressure chamber (or a manifold) and a circuit board delivering an electrical signal to the actuator.

In the configuration, the ink tank and the circuit board may be disposed to extend in the length direction (that is, the first direction) of the pressure chamber or the actuator.

However, the disposition structure of the ink tank and the circuit board may increase a width of the inkjet print head to hinder a miniaturization of the inkjet print head.

Further, in this structure, in the case in which the inkjet print heads are disposed in parallel in order to perform high speed printing (that is, in the case in which the inkjet print heads are disposed in a row in the first direction), a distance between nozzles of neighboring inkjet print heads may be increased, such that printing quality may be deteriorated.

An aspect of the present invention provides an inkjet print head having a significantly reduced width and improved printing quality.

To this end, according to embodiments of the present invention, components causing an increase in width of the inkjet print head may be reduced or rearranged.

For example, according to embodiments of the present invention, the circuit board connected in a row with the actuator may be rearranged such that it is disposed over the actuator, whereby the width of the inkjet print head may be reduced.

In addition, according to embodiments of the present invention, the actuator and the circuit board are connected via a wire capable of being disposed at a wiring interval denser than that of a flexible printed circuit board (FPCB), whereby a plurality of pressure chambers may be more densely disposed.

According to embodiments of the present invention, configured as described above, an interval between nozzles of an inkjet print head may be more densely formed, whereby printing quality may be further improved.

Hereinafter, a detailed configuration of the present invention will be described through embodiments of the present invention.

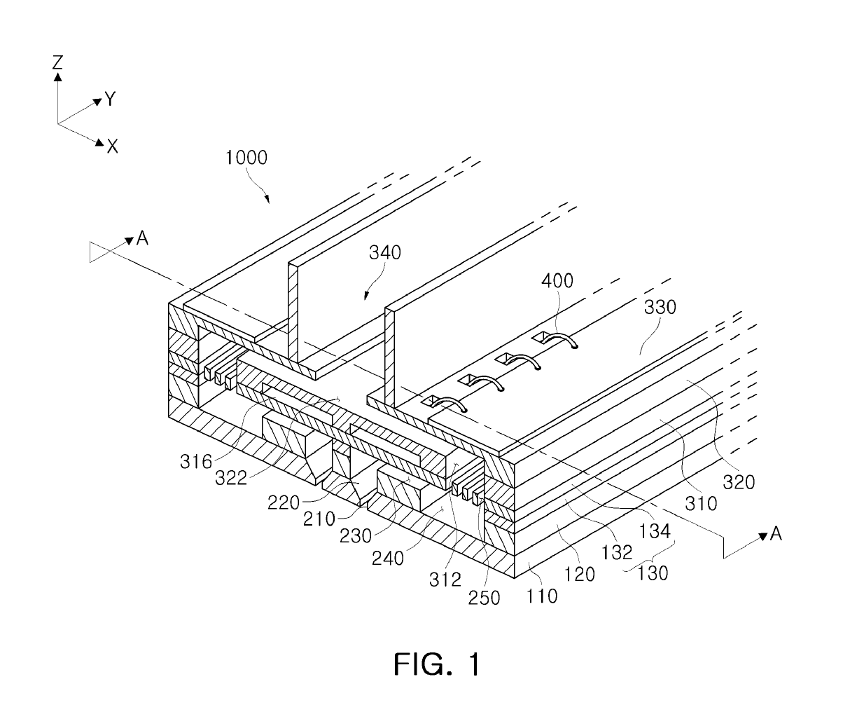

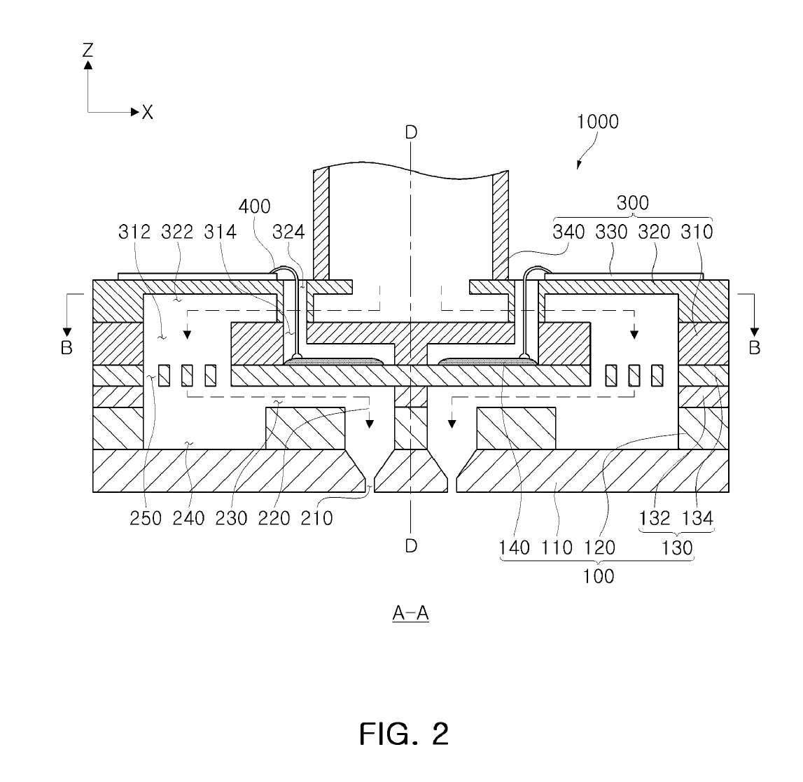

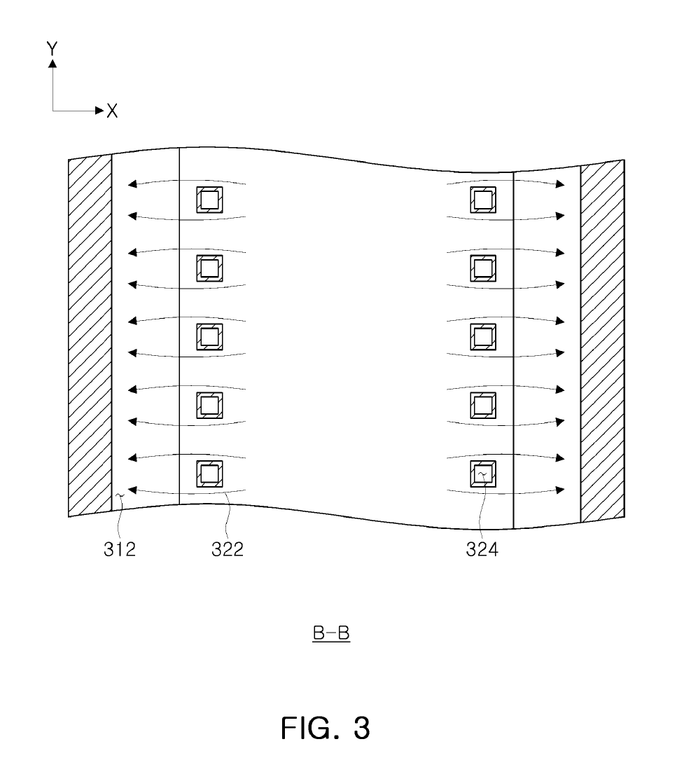

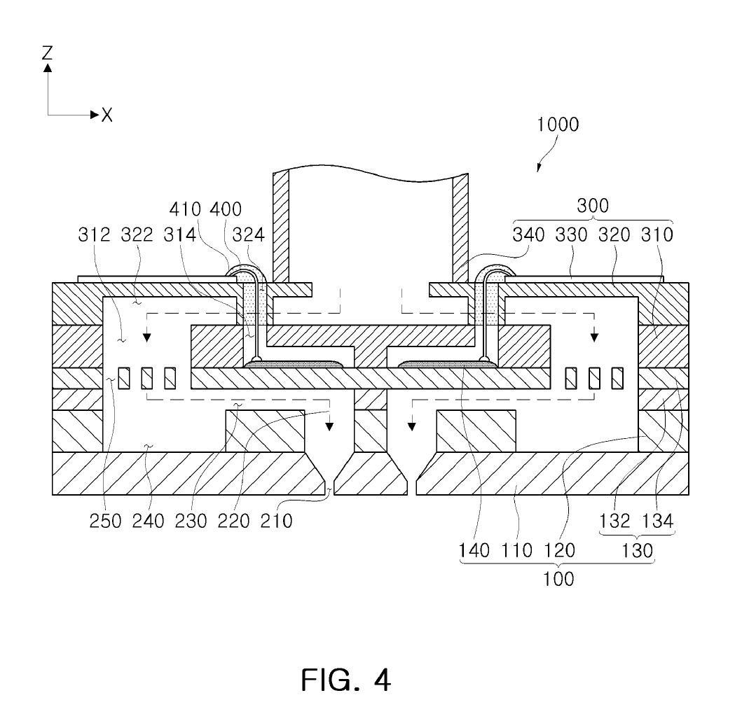

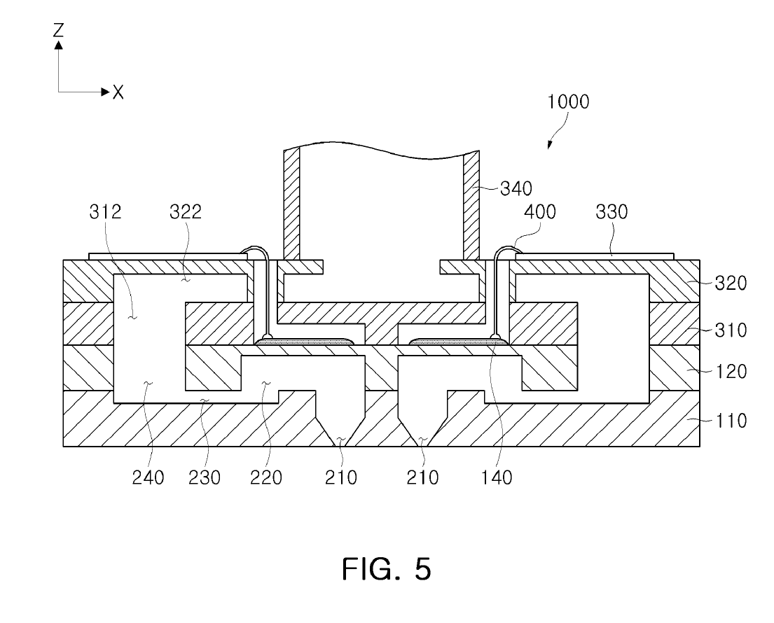

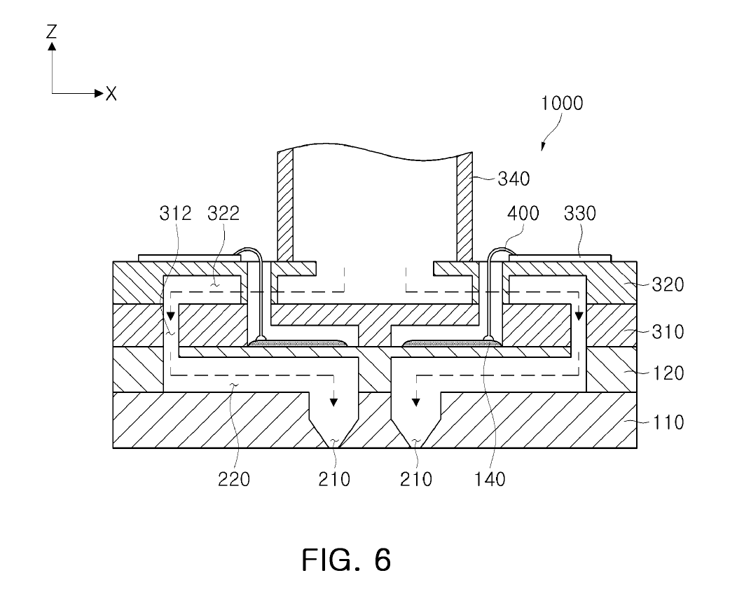

FIG. 1 is a partially cut-away perspective view of an inkjet print head according to a first embodiment of the present invention; FIG. 2 is a cross-sectional view of the inkjet print head of FIG. 1 taken along line A-A; FIG. 3 is a cross-sectional view of the inkjet print head of FIG. 1 taken along line B-B; FIG. 4 is a cross-sectional view of an inkjet print head according to a second embodiment of the present invention; FIG. 5 is a cross-sectional view of an inkjet print head according to a third embodiment of the present invention; and FIG. 6 is a cross-sectional view of an inkjet print head according to a fourth embodiment of the present invention.

An inkjet print head according to a first embodiment of the present invention will be described with reference to FIGS. 1 through 3.

An inkjet print head 1000 according to the first embodiment of the present invention may include an ink discharge unit 100, and ink supply unit 300, and a connection unit 400. Here, the ink discharge unit 100 may include a component discharging ink, and the ink supply unit 300 may include a component supplying the ink to the ink discharge unit 100. In addition, the connection unit 400 may include a component electrically connecting the ink discharge unit 100 and the ink supply unit 300.

Meanwhile, the inkjet print head 1000 may have a structure in which the ink supply unit 300 is disposed over the ink discharge unit 100 as shown in FIG. 1.

Since this structure may allow for a reduction in width of the inkjet print head 1000 (a distance in an X-axis direction in FIG. 1), it may be advantageous for a miniaturization of the inkjet print head 1000.

In addition, since this structure may allow for a reduction in width of the ink discharge unit 100 formed of a relatively expensive material, a manufacturing cost of the inkjet print head 1000 may be reduced.

Hereinafter, configurations of the ink discharge unit 100, the ink supply unit 300, and the connection unit 400 will be described in detail.

The ink discharge unit 100 may discharge the ink stored therein. To this end, the ink discharge unit 100 may include nozzles 210 discharging the ink, pressure chambers 220 temporarily storing the ink therein, and actuators 140 applying pressure to the ink stored in the pressure chambers 220.

The ink discharge unit 100 may include a plurality of substrates. For example, the ink discharge unit 100 may include a first substrate 110, a second substrate 120, and a third substrate 130. In addition, the ink discharge unit 100 may be provided with an oxide layer. The oxide layer may prevent electrical connection between the ink discharge unit 100 and the ink supply unit 300.

The first substrate 110 may form a lower layer of the ink discharge unit 100. The first substrate 110 may be formed of a single crystalline silicon substrate. As necessary, the first substrate 110 may be formed of a silicon on insulator (SOI) substrate. Alternatively, the first substrate 110 may be a lamination substrate in which a silicon substrate and a plurality of insulating members are stacked.

The first substrate 110 may include the nozzles 210. More specifically, the nozzles 210 may extend in a thickness direction (a Z-axis direction in FIG. 1) of the first substrate 110.

The nozzles 210 may be formed in a length direction (a Y-axis direction in FIG. 1) of the first substrate 110 while having a predetermined interval and be formed in a plurality of rows (for reference, in two rows in the embodiment) in a width direction (in the X-axis direction in FIG. 1) of the first substrate 110.

Each nozzle 210 may have a cross-sectional area varied in the thickness direction of the first substrate 110. For example, each nozzle 210 may have a cross-sectional area gradually reduced in a -Z-axis direction as shown in FIG. 1. However, the shape of the nozzle 210 is only an example and is not limited thereto.

The second substrate 120 may form an intermediate layer of the ink discharge unit 100. That is, the second substrate 120 may be stacked on the first substrate 110.

The second substrate 120 may be formed of a single crystalline silicon substrate. As necessary, the second substrate 120 may be formed of a silicon on insulator (SOI) substrate. Alternatively, the second substrate 120 may be a lamination substrate in which a silicon substrate and a plurality of insulating members are stacked.

The second substrate 120 may include the pressure chambers 220 and manifolds 240, and selectively further include restrictors 230.

The pressure chambers 220 may be formed in the second substrate 120. More specifically, the pressure chambers 220 may be formed to penetrate through the second substrate 120 in the Z axis direction. In addition, the pressure chambers 220 may be connected to the nozzles 210 of the first substrate 110 in a state in which the first and second substrate 110 and 120 are coupled.

Each pressure chamber 220 may have a predetermined volume. For example, the volume of the pressure chamber 220 may be equal to or larger than a volume of an ink droplet capable of being discharged by a single operation of the actuator 140. Here, the former may be advantageous for a fixed quantity discharge of the ink and the latter may be advantageous for a continuous discharge of the ink.

The manifolds 240 may be formed in the second substrate 120. Each manifold 240 may extend in the X axis direction and be formed to be spaced apart from the pressure chambers 220 by a predetermined interval, as shown in FIG. 1.

The manifolds 240 may be connected to ink inlets 250 of the third substrate 130. Therefore, the manifolds 240 may store a large quantity of ink therein and supply the stored ink to the pressure chambers 220.

The manifold 240 and ink inlet 250 may be connected to a plurality of the pressure chambers 220. That is, each manifold 240 and each ink inlet 250 may extend in a length direction (the Y axis direction in FIG. 1) of the ink discharge unit 100 and connected to the plurality of pressure chambers 220 and restrictors 230.

However, unlike this, each of a plurality of manifolds 240 and ink inlets 250 may be formed at predetermined intervals in the length direction of the ink discharge unit 100 so as to correspond to the plurality of respective pressure chambers 220.

In this case, since ink is stably supplied to each of the pressure chambers 220, high resolution printing quality may be obtained. Further, in this structure, since each of the pressure chambers 220 may be hardly affected by the pressure chambers neighboring thereto, an influence on cross-talk generated during ink spraying may be reduced.

The third substrate 130 may form an upper layer of the ink discharge unit 100. That is, the third substrate 130 may be an uppermost layer of three substrates.

The third substrate 130 may be formed of a single crystalline silicon substrate. As necessary, the third substrate 130 may be formed of a silicon on insulator (SOI) substrate. Alternatively, the third substrate 130 may be a lamination substrate in which a silicon substrate and a plurality of insulating members are stacked.

The third substrate 130 may include the restrictor 230, and selectively include the pressure chambers 220 and the manifolds 240.

Meanwhile, the third substrate 130 may be formed of at least two substrates. For example, the third substrate 130 may be formed of a substrate 132 in which the restrictors 230 are formed and a substrate 134 vibrating by the actuators 140. However, the third substrate 130 is not necessarily formed of a plurality of substrates.

The restrictors 230 may be formed in the third substrate 130.

The restrictors 230 may be formed so as to connect the pressure chambers 220 and each manifold 240 in a state in which the second and third substrates 120 and 130 are coupled and may control a flow rate of the ink supplied from the manifold 240 to the pressure chambers 220.

Meanwhile, although the embodiment shows that the restrictors 230 are formed in the third substrate 130, the restrictors 230 may be formed in the second substrate 120 as needed.

In addition, the pressure chambers 220 and the manifold 240 may be partially formed in the third substrate 130, as shown in FIG. 1.

The actuators 140 may be formed on an upper surface of the third substrate 130. More specifically, the actuators 140 may be formed on the third substrate 130 so as to correspond to the pressure chambers 220.

Each actuator 140 may include a piezoelectric element and upper and lower electrode members. More specifically, the actuator 140 may be a lamination in which the piezoelectric element is disposed between the upper and lower electrode members.

The lower electrode member may be formed on the upper surface of the third substrate 130. The lower electrode member may be formed of a single conductive metal material or a plurality of conductive metal materials. For example, the lower electrode member may be formed of two metal members containing titanium (Ti) and platinum (Pt).

The piezoelectric element may be formed on the lower electrode member. More specifically, the piezoelectric device may be thinly formed on a surface of the lower electrode member by screen printing, sputtering, or the like. The piezoelectric element may be formed of a piezoelectric material. For example, the piezoelectric element may be formed of a ceramic (for example, PZT) material.

The upper electrode member may be formed on an upper surface of the piezoelectric element. The upper electrode member may be formed of at least one selected from a group consisting of Pt, Au, Ag, Ni, Ti, Cu, and the like.

Each of the actuators 140 configured as described above may be extended and contracted according to an electrical signal and provide driving force for discharging the ink in the pressure chambers 220.

The ink supply unit 300 may be disposed on the ink discharge unit 100. In addition, the ink supply unit 300 may include a plurality of substrates. For example, the ink supply unit 300 may include a fourth substrate 310 and a fifth substrate 320. However, the number of substrates configuring the ink supply unit 300 is not limited thereto, but may be increased or decreased as needed.

The fourth substrate 310 may be formed of a single crystalline silicon substrate. As necessary, the fourth substrate 310 may be formed of a silicon on insulator (SOI) substrate. Alternatively, the fourth substrate 310 may be a lamination substrate in which a silicon substrate and a plurality of insulating members are stacked.

The fourth substrate 310 may include first channels 312 and first penetration holes 314, and further include receiving spaces 316.

The first channels 312 may extend in a thickness direction (that is, the Z axis direction in FIG. 1) of the fourth substrate 310. In addition, the first channels 312 may be connected to the ink inlets 250 of the third substrate 130 and second channels 322.

The first channels 312 may be formed at predetermined intervals in a length direction (that is, the Y axis direction based on FIG. 1) of the fourth substrate 310. That is, each of the first channels 312 may be individually connected to each of the ink inlets 250 to independently supply the ink to each of the pressure chambers 220.

The first penetration holes 314 may be formed in the thickness direction of the fourth substrate 310 and be disposed at predetermined intervals in the length direction of the fourth substrate 310.

In addition, an inner wall of each first penetration hole 314 may be coated with an insulating material. For example, an inner wall of the first penetration hole 314 may be coated with a first oxide film.

Wires may be inserted into the respective first penetration holes 314 so as to be connected to the actuators 140. Here, the wires may not be electrically connected to the fourth substrate 310 due to an insulating material coated on the inner wall of each first penetration hole 314.

The receiving spaces 316 may be formed on a lower surface of the fourth substrate 310 and be disposed at predetermined intervals in the length direction of the fourth substrate 310.

The receiving spaces 316 formed as described above may completely receive the actuators 140 of the third substrate 130 therein.

The fifth substrate 320 may be formed of a single crystalline silicon substrate. As necessary, the fifth substrate 320 may be formed of a silicon on insulator (SOI) substrate. Alternatively, the fifth substrate 320 may be a lamination substrate in which a silicon substrate and a plurality of insulating members are stacked.

The fifth substrate 320 may include the second channels 322 and second penetration holes 324.

The second channels 322 may be formed over first and second surfaces of the fifth substrate 320 and connect the first channels 312 and an ink tank 340. Therefore, ink contained in the ink tank 340 may be supplied to each of the pressure chambers 220 through the second channels 322, the first channels 312, and the ink inlets 250.

Meanwhile, the second channels 322 may extend in a length direction (the Y axis direction based on FIG. 1) of the fifth substrate 320, unlike the first channels 312. The second channel 322 formed as described above may be connected to a plurality of the first channels 312.

The second penetration holes 324 may be formed in a thickness direction of the fifth substrate 320 and be disposed at predetermined intervals in the length direction of the fifth substrate 320. The second penetration holes 324 formed as described above may be connected to the first penetration holes 314, respectively, and form holes penetrating the fourth and fifth substrates 310 and 320 in the Z axis direction.

An inner wall of each second penetration hole 324 may be coated with an insulating material. For example, an inner wall of the second penetration hole 324 may be coated with a second oxide film.

Wires, which are the connection unit 400, may be inserted into holes formed by the first and second penetration holes 314 and 312. Here, the wires may not be electrically connected to the substrates 310 and 312 due to the first and second oxide films formed on the inner walls of the penetration holes 314 and 324.

Meanwhile, the first oxide film of the first penetration hole 314 may have a thickness of several tens of angstrom to 3000 angstrom (Å), and the second oxide film of the second penetration hole 324 may have a thickness of 6000 Å to 1.2 μm. This is due to the fact that the second penetration holes 324 may tend to contact the wires, as compared to the first penetration holes 314.

The second penetration holes 324 may be separated from the second channels 322 as shown in FIG. 3.

Each second penetration hole 324 may form an independent space on the second channel 322 and serve as a resistor controlling a velocity of the ink within the second channel 322.

Each of the nozzles 210, the pressure chambers 220, the restrictors 230, the manifolds 240, the ink inlets 250, the channels 312 and 322, and the penetration holes 314 and 324 formed in the plurality of substrates 110, 120, 130, 310, and 320 as described above may be symmetrical with respect to line D-D. Here, line D-D may be a bisector in the width direction of the inkjet print head 1000.

The ink tank 340 may be disposed in line D-D.

The ink tank 340 may be connected to the second channels 322 and be connected to the pressure chambers 220 that are symmetrical, through the second channels 322. Therefore, the ink contained in the ink tank 340 may be supplied to the pressure chambers 220 that are horizontally symmetrical, (in a direction based on FIG. 1) through the channels 322 and 312.

In the structure as described above, since the ink is supplied to the plurality of pressure chambers 220 disposed in two rows through the single ink tank 340, a disposition space of the ink tank 340 may be reduced as compared to a case in which each of ink tanks 340 is individually disposed for each pressure chamber 220 in each row.

Therefore, according to the embodiment, a miniaturization of the inkjet print head 1000 may be advantageous.

Meanwhile, the ink supply unit 300 may include the ink tank 340 continuously supplying the ink and circuit boards 330 controlling the actuators 140.

The circuit boards 330 may be formed on the fifth substrate 320.

The circuit boards 330 may be symmetrical with respect to the line D-D and be connected to the respective actuators 140.

The circuit boards 330 and the actuators 140 may be electrically connected through the wires, the connection unit 400. Here, since the wires may form wiring intervals denser than those of a circuit pattern on a general flexible printed circuit board, the wires may be advantageous in connecting the actuators 140, disposed densely with relation to each other.

For example, a minimum wiring interval which may be formed on the flexible printed circuit board may be about 200 μm; however, a minimum wiring interval using the wires may be 70 to 100 μm. Therefore, in the case in which the actuators 140 and the circuit boards 330 are connected to each other using the wires, the actuators 140 may be more densely disposed.

This means that the pressure chambers 220 and the nozzles 210 may be more densely formed. Therefore, according to the embodiment, an interval between the nozzles 210 may be more densely formed, whereby printing quality may be improved.

Hereinafter, other embodiments of the present invention will be described with reference to FIGS. 4 through 6.

The inkjet print head 1000 according to a second embodiment of the present invention may be different from the inkjet print head according to the first embodiment of the present invention in that it further include an elastic material 410 as shown in FIG. 4.

Since the wires inserted into the penetration holes 312 and 322 may have a significantly thin thickness and low rigidity, the wires may be cut off due to external impacts. According to the embodiment, in consideration of this point, the penetration holes 314 and 324 may be filled with the elastic material 410.

The elastic material 410 may be an epoxy resin, or the like, capable of absorbing impacts and may significantly reduce a wire damage.

The inkjet print head 1000 according to a third embodiment of the present invention may be different from the inkjet print heads according to the above-mentioned embodiments of the present invention in terms of a configuration of the ink discharge unit 100.

As shown in FIG. 5, the ink discharge unit 100 may include two substrates 110 and 120.

The first substrate 110 may include the nozzles 210 and the restrictors 230, and the second substrate 120 may include the pressure chambers 220 and the manifolds 240.

In addition, the ink inlets 250 may be omitted in the embodiment, and the manifolds 240 may be connected directly to the first channels 312.

Since the inkjet print head 1000 formed as described above may be manufactured using a relatively small number of substrates (four sheets), a manufacturing cost thereof may be reduced.

The inkjet print head 1000 according to a fourth embodiment of the present invention may be different from the inkjet print heads according to the above-mentioned embodiments of the present invention in terms of a structure thereof in which the restrictors 230 and the manifolds 240 are omitted.

Generally, the restrictors in the inkjet print head 1000 may serve to control a flow rate of ink supplied to the pressure chambers and prevent a backward flow phenomenon generated during an ink discharging.

However, since the inkjet print head 1000 shown in FIG. 6 has a structure in which the ink tank 340 and the pressure chambers 220 are connected through the plurality of channels 322 and 312, the restrictors and the manifolds may be omitted therefrom.

That is, according to the embodiment, the second channels 322 may serve as manifolds distributing the ink contained in the ink tank 340 to the plurality of pressure chamber 220. In addition, the first channels 312 may serve as restrictors controlling an amount of ink supplied to the pressure chambers 220 and preventing the ink contained in the pressure chambers 220 from flowing backwardly to the ink tank 340.

In the inkjet print head 1000 as described above, an etching shape of a substrate may be simplified. Thus, the inkjet print head 1000 may be easily manufactured.

As set forth above, according to the embodiments of the present invention, a circuit board connected to an actuator is disposed in a height direction of the ink discharge unit, whereby a width of the inkjet print head may be reduced.

Therefore, according to the embodiments of the present invention, even in the case in which a plurality of inkjet print heads are disposed in a width direction thereof in order to increase a printing speed, printing quality of the inkjet print heads may not be deteriorated.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head comprising:
an ink discharge unit including nozzles, pressure chambers, restrictors, manifolds, and actuators;
an ink supply unit including an ink tank supplying ink to the manifolds and circuit boards delivering control signals to the actuators; and
a connection unit electrically connecting the circuit boards and the actuators,
wherein the ink supply unit is formed integrally with the ink discharge unit.

2. The inkjet print head of claim 1, wherein the ink supply unit includes a penetration hole into which the connection unit is inserted.

3. The inkjet print head of claim 2, wherein the connection unit is a wire inserted into the penetration hole.

4. The inkjet print head of claim 3, wherein the penetration hole is filled with an epoxy resin so as to allow the wire to be stably fixed therein.

5. The inkjet print head of claim 3, wherein an inner wall of the penetration hole is coated with an insulating material.

6. The inkjet print head of claim 3, wherein the penetration hole includes a first oxide film formed on a lower inner wall thereof and a second oxide film formed on an upper inner wall thereof, and
the second oxide film has a thickness greater than that of the first oxide film.

7. The inkjet print head of claim 1, wherein the ink supply unit and the ink discharge unit further include an oxide layer formed therebetween.

8. The inkjet print head of claim 1, wherein the ink supply unit includes a channel connecting the manifolds and the ink tank.

9. The inkjet print head of claim 8, wherein the channel is provided with a pillar for reducing a pressure wave generated during an ink discharging operation by the actuators.

10. The inkjet print head of claim 9, wherein the pillar has a penetration hole formed therein and having the connection unit inserted thereinto.

11. The inkjet print head of claim 1, wherein the ink tank is disposed at a bisection point of the ink supply unit in a first length direction.

12. The inkjet print head of claim 11, wherein the nozzles, the pressure chambers, the restrictors, the manifolds, and the actuators are formed to be symmetrical with respect to the ink tank.

13. The inkjet print head of claim 11, wherein the circuit boards are disposed to be symmetrical with respect to the ink tank.

14. The inkjet print head of claim 1, wherein the ink discharge unit includes:
a first substrate having the nozzles formed therein;
a second substrate having the pressure chambers and the manifolds formed therein; and
a third substrate having the restrictors and ink inlets formed therein, the restrictors connecting the pressure chambers and the manifolds, and the ink inlets connecting the manifolds and the ink tank.

15. The inkjet print head of claim 1, wherein the ink discharge unit includes:
a first substrate having the nozzles formed therein; and
a second substrate having the pressure chambers, the restrictors, the manifolds, and ink inlets formed therein, the ink inlets connecting the manifolds and the ink tank.

16. The inkjet print head of claim 1, wherein the ink supply unit includes:
a fourth substrate having a first channel and a first penetration hole formed therein, the first channel being connected to the manifolds, and the first penetration hole having the connection unit inserted thereinto;
a fifth substrate having a second channel and a second penetration hole formed therein, the second channel connecting the ink tank and the first channel, and the second penetration hole being connected to the first penetration hole;
the circuit boards formed on the fifth substrate and connected to the actuators; and
the ink tank formed on the fifth substrate and supplying the ink to the pressure chambers.

17. An inkjet print head comprising:
an ink discharge unit including nozzles, pressure chambers, and actuators;
an ink supply unit including circuit boards delivering control signals to the actuators; and
a connection unit electrically connecting the circuit boards and the actuators,
wherein the ink supply unit is formed integrally with the ink discharge unit.

18. The inkjet print head of claim 17, wherein the ink supply unit includes a penetration hole into which the connection unit is inserted.

19. The inkjet print head of claim 18, wherein the connection unit is a wire inserted into the penetration hole.

20. The inkjet print head of claim 19, wherein the penetration hole is filled with an epoxy resin so as to allow the wire to be stably fixed therein.

21. The inkjet print head of claim 19, wherein an inner wall of the penetration hole is coated with an insulating material.

22. The inkjet print head of claim 19, wherein the penetration hole includes a first oxide film formed on a lower inner wall thereof and a second oxide film formed on an upper inner wall thereof, and
the second oxide film has a thickness greater than that of the first oxide film.

23. The inkjet print head of claim 17, wherein the ink supply unit and the ink discharge unit further include an oxide layer formed therebetween.

24. The inkjet print head of claim 17, wherein the ink supply unit includes a channel connected to the pressure chambers.

25. The inkjet print head of claim 24, wherein the channel is provided with a pillar for reducing a pressure wave generated during an ink discharging operation by the actuators.

26. The inkjet print head of claim 25, wherein the pillar has a penetration hole formed therein and having the connection unit inserted thereinto.
